(19) United States
(12) Patent Application Publication
(10) Pub. No.: US 2010/0219079 A1
(43) Pub. Date: Sep. 2, 2010

(54) METHODS FOR MAKING MEMBRANES BASED ON ANODIC ALUMINUM OXIDE STRUCTURES

(75) Inventors: Dmitri Routkevitch, Longmont, CO (US); Oleg G. Polyakov, Fort Collins, CO (US)

Correspondence Address: MARSH, FISCHMANN & BREYFOGLE LLP, 8055 East Tufts Avenue, Suite 450, Denver, CO, 80237, US

(73) Assignee: SYNKERA TECHNOLOGIES, INC., Longmont, CO (US)

(21) Appl. No.: 12/715,379

(22) Filed: Mar. 1, 2010

Related U.S. Application Data
(63) Continuation-in-part of application No. 11/745,449, filed on May 7, 2007.
(60) Provisional application No. 60/767,513, filed on May 7, 2006.

(51) Int. Cl. C25D 11/12; C25D 11/08; C25D 11/06; C25D 5/48

(52) U.S. Cl. 205/175; 205/329; 205/332; 205/220

(57) ABSTRACT

Membranes including anodic aluminum oxide structures that are adapted for separation, purification, filtration, analysis, reaction and sensing. The membranes can include a porous anodic aluminum oxide (AAO) structure having pore channels extending through the AAO structure. The membrane may also include an active layer, such as one including an active layer material and/or active layer pore channels. The active layer is intimately integrated within the AAO structure, thus enabling great robustness, reliability, resistance to mechanical stress and thermal cycling, and high selectivity. Methods for the fabrication of anodic aluminum oxide structures and membranes are also provided.

### CROSS-REFERENCE TO RELATED APPLICATIONS

This application claims priority as a continuation-in-part application to U.S. patent application Ser. No. 11/745,449 filed May 7, 2007, which claims priority to U.S. Provisional Patent Application Ser. No. 60/767,513, filed on May 7, 2006. Each of the foregoing U.S. patent applications is incorporated herein by reference in its entirety.

### STATEMENT REGARDING FEDERALLY-FUNDED RESEARCH

This invention was funded in part by the National Science Foundation under Grant Nos. 0420147, 0548757, 0539824 and 0724478, and by the Department of Energy under Grant No. DE-FG02-04ER84086, each administered by the Small Business Innovation Research (SBIR) program. The Government has certain rights in this invention.

### BACKGROUND OF THE INVENTION

1. Field of the Invention

The present invention relates to methods for making membranes based on anodic aluminum oxide (AAO) structures and applications of the membranes. The membranes may include two or more layers differing by morphology (e.g., pore size) and/or by composition. A membrane having two or more layers may include a first layer including pore channels having a relatively large diameter and a second layer including either pore channels having a smaller diameter, an active layer material, or both.

2. Description of Related Art

Efficient and cost-effective membranes are needed in many applications, including the separation and purification of gaseous and liquid media. Examples include the purification of gases such as hydrogen (H₂) for use in fuel cells, separation of biological macromolecules, such as proteins, in biomedical research and biomanufacturing, purification of water, air purification and many other applications. As an example, it is often necessary to remove contaminant gases such as carbon monoxide (CO) from a gas stream containing H₂. As another example, it is often desired to fractionate proteins in an aqueous solution based on the molecular weight of the proteins.

In some membranes, commonly referred to as bulk membranes, the entire membrane body performs the separating function. Other membranes, such as supported or asymmetric membranes, include a membrane support and an active layer, where the active layer is permeable to only one type of species or a select group of species. In supported membranes, the structure and the properties of the active layer predominately define the overall membrane performance and reliability. The ideal membrane would have a very thin (to enable high permeance), very uniform (to enable good selectivity), yet highly robust and well integrated active layer. However, the production and implementation of such membranes is very challenging.

In the case of H₂ separation, active layers are often comprised of active layer materials such as metals and metal alloys, particularly those including palladium (Pd), which are impervious to all gases except H₂ and thereby separate the H₂ from the other gases. Such membranes can be fabricated in the form of self-supporting bulk foils. Although Pd-based bulk foils exhibit near-infinite selectivity for H₂, they are expensive and have poor flux due to the high foil thickness required for sufficient mechanical robustness.

Active layers of thin Pd-based films can be used to increase H₂ permeance but need to be supported by porous substrates. To ensure that such membranes are defect-free on a practical scale, the typical thickness of Pd-based supported films is least 10 μm to 50 μm, which is still too thick to enable the high permeance required by many applications. One of the factors driving up the thickness of the supported film is the broad pore size distribution of typical porous substrates.

Recently, microfabrication technology has been applied to supported membranes to generate defect-free high permeability membranes, as is reported by Karnik et al. (“Towards a palladium micro-membrane for the water gas shift reaction: microfabrication approach and hydrogen purification results”, Journal of Microelectromechanical Systems, February 2003, Vol. 12, Issue 1, pgs. 93-100). Submicron-thick Pd “windows” produced on etched silicon wafers demonstrated large hydrogen flux as a function of Pd area and high selectivity. However, the total area of the supported Pd membrane was small, limiting the total flux. Additionally, the Pd windows ruptured when subjected to trans-membrane pressures of about 0.5 bar, and the thermal reliability of the thin Pd film on Si was a problem due to the mismatch of temperature expansion coefficients.

Although thin-film supported membranes, such those described above, have been implemented, their commercial utility has been very limited. Such membranes have problems related to poor adhesion of the active layer to the porous support, damage to the thin films caused by thermal cycling and susceptibility to damage from mechanical loads and abrasion. This leads to membrane failures during typical operating conditions. Both uniform pore structure of the support and new methods of integration of the active layer are needed to address these issues and to realize better performance and reliability. Also, new methods for the reliable sealing of thin supported membranes are needed to reduce the cost of the manufacturing and integration of such membranes that has hindered their widespread application.

Films of Anodic Aluminum Oxide (AAO) include elongated mesopores that extend through the entire thickness (Furneau et. al., Nature, 71, p. 337 (1992)), and have been utilized as a substrate for different types of membranes. For example, Pd films as thin as 200 nm have been sputtered onto the surface of AAO for a H₂ separation membrane, as is reported by Konno et al. (“A Composite Palladium and Porous Aluminum Oxide Membrane for Hydrogen Gas Separation”, J. Membr. Sci., Vol. 37, pp. 193-197, 1988) and Mardilovich et al. (“Gas Permeability of Anodized Alumina Membranes with a Palladium-Ruthenium Alloy Layer”, Russian J. Phys. Chem., Vol. 70, pp. 514-517, 1996). The resulting membranes exhibit high selectivity and permeability for H₂. However, although conventional AAO structures could support a much thinner active layer, the active layer resides on the membrane surface and is prone to hydrogen embrittlement and mechanical damage.

Itoh et al. (“Deposition of Palladium Inside Straight Mesopores of Anodic Alumina Tube and its Hydrogen Permeability”, Micropor. and Mesopor. Mat. and Chem. Res., Vol. 39, pp. 103-111, 2000) report that Pd was deposited inside the pores of AAO for the fabrication of membranes for the separation of H₂. Fabrication of these membranes involved sputtering of a conductive contact from Pd, Pt or Ag onto one of the surfaces of the blank AAO membrane, followed by the electrodeposition of Pd, resulting in an active layer comprised of the Pd deposited onto the contact film on the membrane surface as well as inside the AAO pores. The method does not allow the formation of the active layer disposed entirely within the nanoporous support structure.

Another application of membranes is filtration in liquid media, such as from the low end of the microfiltration (pore size of greater than 20 nm to 100 nm) to ultrafiltration (UF, pore size of 5 to 100 nm) and nanofiltration (NF, pore size of 1 to 10 nm), which are important steps in many laboratory and industrial processes. For example, UF membranes are being used widely in biotechnology, by pharmaceutical and food industries (for both manufacturing and analytical process control), and in bio-related and health-related research. In medical care, hemodialysis is currently the leading application of UF membranes. NF membranes are used in solution purification from small molecules and multivalent ions.

Existing liquid filtration membranes, such as polymer membranes, have significant drawbacks limiting their separation performance in many separations applications. Wan et. al. (“Fractionation of proteins using ultrafiltration: developments and challenges”, Dev. Chem. Eng. Miner. Process, 2005, 13(1/2), 121-136) and Ghosh (“Protein Bioseparation Using Ultrafiltration: Theory, Applications and New Developments”, 2003, Imperial College Press, London) provide an extensive review of the challenges, the most significant of which are broad pore size distribution and fouling.

Broad pore size distribution, inherent in the commercial polymer membranes, limits the selectivity of the membranes. Fouling occurs when proteins adsorb on the membrane surface or within the pores, resulting in decreased flow rate and diminished selectivity.

New developments in UF membranes are still at an early stage and are related primarily to studying new membrane materials and filtration techniques.

Commercially available UF membranes are almost always based on polymer materials, which exhibit very irregular pore size and shape. Polysulfones, cellulose, polyvinyls, and various derivatives are commonly used as base materials for UF membranes, and provide a foam-like porous architecture with broad pore size distribution. Zhang et. al. (“Selective separation of proteins by microfiltration with formed-in place Membranes”, Desalination, 1993, 90, pp. 137-146) and Rabiller-Baudry et. al. (“Ultrafiltration of mixed protein solutions of lysozyme and lactoferrin: role of modified inorganic membranes and ionic strength on the selectivity”, J. Membrane Sci. 2001, 184, 137-148) showed that more regular pores (such as in anodized titanium oxide) can have a positive impact on selectivity. It is generally believed that narrower pore size distribution and more regular pore shape can help achieve greater permeance and selectivity. In this regard, AAO has a high level of pore uniformity and is a good material for use in membrane applications. However, both nanoporous architecture of AAO structures and the specific implementations of active layers integrated in AAO reported in the prior art are insufficient in enabling full potential of this material in membrane applications. Currently, there are no commercially available AAO membranes on market with highly uniform pores of diameter 20 nm or less.

In terms of the role of the overall membrane architecture on performance, small thickness of the active layer and a large pore diameter in the membrane support layer are important in providing high permeance.

Achieving large pore diameter in an AAO structure requires large pore period (average distance between the pore centers). It is known to those skilled in the art that the pore period linearly depends on the anodization voltage; at approximately 2 to 3 nm per volt for most known electrolytes. In general, any specific electrolyte at a given temperature has an upper voltage limit, above which stable anodization cannot be performed and a uniform AAO structure is not formed. Conventional anodization is typically carried out in the range of voltages from 20 to 225 V, resulting in a pore period from about 40 to about 500 nm, and pore diameters from about 15 nm to 150 nm. Some of the recently reported anodization electrolytes and methods result in the growth of AAO with a pore period of: (i) about 500 nm at about 120 V (Jia et. al. “Preparation and characteristics of well-aligned macroporous films on aluminum by high voltage anodization in mixed acid”, Surface & Coatings Technology 2006, vol. 201, pp. 513-518); (ii) about 450 nm at about 180 V (Li at. al. “Fabrication of porous alumina templates with a large-scale tunable interpore distance in a H2C2O4-C2H5OH—H2O solution”, Chinese Science Bulletin 2008, vol. 53, pp. 1608-1612); and (iii) less than 400 nm at 225 V (Kuang et. al. “Preparation and analysis of films on aluminum by high voltage anodization in phosphoric acid and sodium tungstate solution”, Journal of Applied Electrochemistry 2001, vol. 31, pp. 1267-1271).

Achieving larger pore diameters and pore periods requires anodization at voltages beyond the upper values reported in the literature. Simply increasing anodization voltage in known electrolytes does not work—the resulting AAO films do not have a well-organized structure, the pores are not uniform, and the dielectric breakdowns and arcing during anodization prevent making a membrane with acceptable integrity. Another challenge is the uniformity of the pore diameter along the pore length. At high-voltage anodization, anodization starts at a relatively low voltage and achieves the targeted voltage only after a substantial thickness of AAO has been grown. Such an initial AAO layer grown at smaller voltages will have smaller pores, which is unacceptable for certain applications of AAO, e.g., for fabricating microchannel plates.

Overall, reduction to practice of many AAO-based components and products, especially membranes, is impeded by the lack of methods for making AAO with: (i) large pore period and large-diameter pores in the support layer, which is needed to sustain high permeance and decrease fouling; (ii) small thickness of the active layer, which provides high permeance; (iii) highly controllable pore size in the active layer, which provides membrane selectivity; and (iv) high mechanical and thermal robustness.

### SUMMARY OF THE INVENTION

In view of the foregoing, it is one objective of the present invention to provide a membrane based on an anodic aluminum oxide structure that has improved separation selectivity for the species of interest. A further objective is to provide a method for making a membrane that may have reduced fouling. It is a further objective to provide a method for making a membrane that may have high separation selectivity and low fouling while sustaining high permeance. A further objective is to provide a method for making a membrane that may have improved resistance to thermal cycling. A further objective is to provide a method for making a membrane that may have improved chemical resistance. A further objective is to provide a method for making a membrane that may have improved mechanical reliability. It is a further objective to provide a method for making a membrane that may have improved adhesion of the active layer to the support layer. It is another objective to provide a method for making a membrane that is attached to a metal rim for sealing and integration of membranes into membrane modules and separating systems.

A membrane according to the present invention can include a porous support layer and an active layer adjacent to the porous support layer. An external surface of the support layer may comprise a first major membrane surface and an external surface of the active layer may comprise an opposed second major membrane surface. The support layer may include substantially parallel elongate pores (e.g., pore channels) extending through the support layer from the first major membrane surface to an interface between the support layer and active layer. The active layer may include active layer pore channels (e.g., having a smaller diameter than the support layer pore channels) extending from the interface to the second major membrane surface. According to one aspect, the membrane comprises an anodic aluminum oxide (AAO) structure. According to a further aspect, the active layer includes an active layer material that is spaced inwardly from each of the first and second major surfaces, such as by at least about 1 nm.

The present invention includes methods for the fabrication of anodic aluminum oxide structures, including aluminum oxide structures that may be useful as membranes for a wide variety of applications. The methods may advantageously be utilized to fabricate anodic aluminum oxide structures having relatively large pore channels in the support layer. The methods may also be utilized to fabricate anodic aluminum oxide structures having a relatively large pore period (e.g., distance between adjacent pore centers) in the support layer. The methods may also be utilized to fabricate anodic aluminum oxide structures having a relatively large thickness. The methods may also be utilized to fabricate anodic aluminum oxide structures having a relatively thin active layer, e.g., a thin layer of pore channels having an average diameter that is less than the average pore channel diameter of the support layer.

According to one embodiment, a method for fabricating an anodic aluminum oxide structure having a plurality of support layer pore channels is provided. The method may include the steps of providing an aluminum metal substrate, contacting the aluminum metal substrate with an electrolyte, and anodizing the aluminum metal substrate in contact with the electrolyte at an anodizing voltage of at least about 100V. In this regard, the electrolyte may include at least one electrolyte component selected from the group consisting of: i) metal salts of a pore forming electrolyte acid selected from oxalic acid, sulfuric acid, phosphoric acid, citric acid and malonic acid; ii) a non-pore forming compound selected from the group consisting of boric acid, sodium borate, ammonium borate, ammonium phosphate, ammonium oxalate, and ammonium adipate; and iii) an organic polar solvent. The method may advantageously be used to fabricate an anodic aluminum oxide structure at relatively high anodizing voltages, where the structure may have pore channels with a relatively large pore channel diameter, for example.

A number of feature refinements and additional features may be separately applicable to the foregoing embodiment. These feature refinements and additional features may be implemented individually or in any combination. In one aspect, the method may include the use of an anodizing voltage of at least about 200V, such as from about 200V to about 1000V, such as from about 200V to about 600V. According to another aspect, the electrolyte may include a pore-forming electrolyte acid selected from the group consisting of oxalic acid, sulfuric acid, phosphoric acid, citric acid and malonic acid. For example, the electrolyte may be an aqueous-based electrolyte.

In another aspect, when the electrolyte component comprises a metal salt of the pore forming electrolyte acid, the metal salt may comprise an oxalate salt, for example. Further, the metal salt may include a complex salt, the complex salt comprising at least a first cation selected from Group I or Group II elements and at least a second cation selected from Group III or Group IV elements. For example, the first cation of the complex salt may be selected from potassium, calcium and magnesium, and the second cation of the complex salt may be selected from aluminum and titanium.

According to another aspect, when the electrolyte comprises a non-pore forming compound selected from the group consisting of boric acid, sodium borate, ammonium borate, ammonium phosphate, ammonium oxalate and ammonium adipate, the electrolyte may also comprise a pore forming electrolyte acid, such as one selected from the group consisting of oxalic acid, sulfuric acid, phosphoric acid, citric acid, malonic acid and mixtures thereof. In another aspect, when the electrolyte component is an organic polar solvent, the electrolyte may also include a pore forming acid. In one aspect, the organic polar solvent comprises an alcohol.

According to another aspect, the method may further include the step of forming a non-porous layer of aluminum oxide on the aluminum metal substrate before anodizing the substrate at the anodizing voltage. The method may also include the step of applying a mask to the aluminum substrate before the anodizing step to selectively anodize a portion of the aluminum metal substrate.

In another aspect, the method may be used to form an anodic aluminum oxide structure wherein the pore channels have an average pore diameter of at least about 200 nm and an average pore period (e.g., distance from center-to-center of adjacent pore channels) of at least about 500 nm. For example, the pore channels may have an average pore diameter of at least about 1000 nm and an average pore period of at least about 2000 nm.

According to another embodiment, a method for fabricating an anodic aluminum oxide structure having a plurality of support layer pore channels is provided. The method may include the steps of providing an aluminum metal substrate, contacting the aluminum metal substrate with a non-pore forming electrolyte, and first anodizing the aluminum metal substrate in contact with the non-pore forming electrolyte at a first anodizing voltage to form a substantially non-porous layer of aluminum oxide on the aluminum metal substrate. After the first anodizing step, the method may include contacting the aluminum metal substrate with a pore forming electrolyte and second anodizing the aluminum metal substrate in contact with the pore forming electrolyte at a second anodizing voltage of at least about 100V to form an anodic aluminum oxide structure having a plurality of pore channels.

A number of feature refinements and additional features may be separately applicable to the foregoing embodiment. These feature refinements and additional features may be implemented individually or in any combination. According to one aspect, the non-pore forming electrolyte may include a compound selected from the group consisting of boric acid, sodium borate, ammonium borate, ammonium phosphate, ammonium oxalate and ammonium adipate.

According to another aspect, the first anodizing step may be carried out for a period of time such that the non-porous layer of aluminum oxide has a thickness of at least about 1 nm and not greater than about 5000 nm. According to another aspect, the second anodizing voltage is at least about 200V, such as from about 200V to about 1000V, such as from about 400V to about 600V.

According to another aspect, the pore forming electrolyte may include an acid selected from the group consisting of oxalic acid, sulfuric acid, phosphoric acid, citric acid, malonic acid and mixtures thereof. The method may be used to form an anodic aluminum oxide structure wherein the pore channels have an average pore diameter of at least about 200 nanometers and an average pore period of at least about 500 nanometers, for example. The method may further include the step of chemically etching the pore channels to increase the pore diameter of the pore channels.

According to another aspect, the pore forming electrolyte may include at least one electrolyte component selected from the group consisting of: i) metal salts of a pore-forming electrolyte acid selected from oxalic acid, sulfuric acid, phosphoric acid, citric acid and malonic acid; ii) a non-pore forming acid selected from the group consisting of boric acid, sodium borate, ammonium borate, ammonium phosphate, ammonium oxalate and ammonium adipate; and an organic polar solvent.

According to another embodiment, a method for the fabrication of an anodic aluminum oxide structure having a plurality of support layer pore channels is provided. The method may include the steps of providing an aluminum metal substrate, contacting the aluminum metal substrate with a first pore forming electrolyte and anodizing the aluminum metal substrate in contact with the pore forming electrolyte by applying an anodizing voltage to the aluminum metal substrate to form an anodic aluminum oxide structure. The anodic aluminum oxide structure may include a base layer comprising the plurality of pore channels and a barrier layer disposed between the base layer and the aluminum metal substrate. The method may further include the steps of contacting the aluminum oxide structure with a second electrolyte and electrochemically removing at least a portion of the barrier layer to form secondary pores in the barrier layer.

A number of feature refinements and additional features may be separately applicable to the foregoing embodiment. These feature refinements and additional features may be implemented individually or in any combination. According to one aspect, the electrochemically removing step may include the step of applying a dissolution voltage across the barrier layer while in contact with the second electrolyte, wherein the second electrolyte comprises an acid selected from the group consisting of hydrochloric acid, perchloric acid, acetic acid and mixtures thereof. For example, the dissolution voltage may be at least about 0.5 V and not greater than about 1000 V, such as at least about 2 V and not greater than about 400 V.

According to another aspect, the step of electrochemically removing at least a portion of the barrier layer separates the anodic aluminum oxide structure from the aluminum metal substrate.

The secondary pores may have an average diameter in the range of from about 1 nm to about 300 nm, and not greater than the average diameter of the pore channel.

According to another embodiment, a method for fabricating an anodic aluminum oxide structure having a plurality of support layer pore channels is provided, where the anodic aluminum oxide structure may have an increased thickness as compared to typical anodic aluminum oxide structures. The method may include the steps of providing an aluminum metal substrate, contacting the aluminum metal substrate with a first pore forming electrolyte, and first anodizing the aluminum metal substrate to form a first anodic aluminum oxide layer by applying a first anodizing voltage to the aluminum metal substrate. The method may also include the steps of applying a protective coating over at least a portion of the first anodic aluminum oxide layer, contacting the aluminum metal substrate with a second pore forming electrolyte, and second anodizing the aluminum metal substrate in contact with the second pore forming electrolyte to form a second anodic aluminum oxide layer, where the first anodic aluminum oxide layer and the second anodic aluminum oxide layer form an anodic aluminum oxide structure having an average thickness of at least about 100 μm. The protective coating may be substantially insoluble in the second pore forming electrolyte.

A number of feature refinements and additional features may be separately applicable to the foregoing embodiment. These feature refinements and additional features may be implemented individually or in any combination. According to one aspect, the second pore forming electrolyte is the same as the first pore forming electrolyte. According to another aspect, the protective coating is selected from a polymer or a metal oxide, and can be a polymer coating for example. The applying step may include dip-coating the first anodic aluminum oxide layer in a polymer solution. In another aspect, the protective coating may include a self-assembled layer. In another aspect, the protective coating may be applied to the first anodic aluminum oxide layer in a liquid phase, or may be applied to the first anodic aluminum oxide layer in a gas phase.

In one aspect, the first anodic aluminum oxide layer has a thickness of not greater than about 200 μm. The foregoing method can be used to fabricate an anodic aluminum oxide structure of increased thickness, and in one aspect the anodic aluminum oxide structure has an average thickness of at least about 2 mm. For example, the method may include the steps of applying a second protective coating over at least a portion of the second anodic aluminum oxide layer, contacting the aluminum metal substrate with a third pore forming electrolyte, and third anodizing the aluminum metal substrate in contact with the third pore forming electrolyte to form a third anodic aluminum oxide layer, wherein the second protective coating is substantially insoluble in the third pore forming electrolyte, and wherein the anodic aluminum oxide structure has an average thickness of at least about 2 mm.

Any of the foregoing methods may further include the step of second anodizing the aluminum metal substrate at a second anodizing voltage, wherein the second anodizing voltage is less than the first anodizing voltage, to form an active layer in the aluminum oxide structure comprising active layer pore channels having an average pore diameter that is less than the diameter of the support layer pore channels. In one aspect, the second anodizing voltage may be reduced during the second anodizing step.

### DESCRIPTION OF THE DRAWINGS

FIG. 1 illustrates a schematic representation of the structure of a membrane including an anodic aluminum oxide structure according to an embodiment of the present invention.

FIGS. 2(a)-(e) illustrate a schematic representation of a membrane including an anodic aluminum oxide structure according to various embodiments of the present invention as compared to the prior art.

FIGS. 3(a)-(d) schematically illustrate a method for the fabrication of a membrane according to an embodiment of the present invention.

FIGS. 4(a)-(d) schematically illustrate a method for the fabrication of a membrane including an anodic aluminum oxide structure according to an embodiment of the present invention.

FIG. 5 illustrates a method for the fabrication of a membrane including an anodic aluminum oxide structure and having a metal rim according to an embodiment of the present invention.

FIGS. 6(a)-(b) illustrate anodization voltage reduction profiles and the corresponding current density according to an embodiment of the present invention.

FIGS. 7(a)-(b) illustrates the length of Pd nanowires growing inside the membrane pores as a function of deposition time according to an embodiment of the present invention.

FIG. 8 illustrates the flux of H₂ and Ar through a membrane including an anodic aluminum oxide structure according to an embodiment of the present invention.

FIG. 9 illustrates the temperature cycling stability of a membrane including an anodic aluminum oxide structure according to an embodiment of the present invention.

FIG. 10 illustrates the molecular weight cut off achieved with a membrane including an anodic aluminum oxide structure according to an embodiment of the present invention versus a commercial polymer membrane in ultrafiltration of proteins.

FIG. 11 illustrates the Membrane Fouling Index (MFI) of a membrane including an anodic aluminum oxide structure according to an embodiment of the present invention versus a commercial polymer membrane in ultrafiltration of a protein solution.

### DESCRIPTION OF THE INVENTION

The present invention is directed to the methods for making membranes including anodic aluminum oxide (AAO) structures, including asymmetric membranes, for selective separation of species of interest in gaseous or liquid media. Examples include purification of gases such as hydrogen (H₂) and nanofiltration, ultrafiltration and microfiltration of liquid solutions, colloids and suspensions. Asymmetric membrane structures may include a relatively thick porous support layer with relatively large-diameter pore channels that are in communication (e.g., fluid communication) with one or more active layers that comprise smaller-diameter pore channels and/or an active layer material(s) disposed within the active layer pore channels. The active layer may advantageously be thinner than the support layer. Generally, a larger pore channel diameter of the support layer combined with a thin active layer advantageously increases membrane permeance and decreases fouling. A thicker support layer also may increase the mechanical robustness of the membrane. Uniformity of both the pore diameter and the composition of the active layer may enable high selectivity to species of interest. Monolithic integration of the support layer and the active layer may greatly enhance membrane durability and reliability in changing operating conditions and may extend useful membrane lifetime.

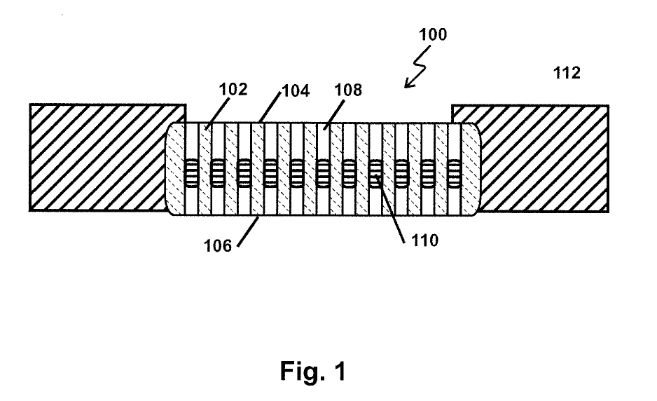

Referring to FIG. 1, a membrane 100 includes a porous AAO structure 102 and one or more active layers 110. As illustrated in FIG. 1, the active layer 110 comprises an active layer material that is disposed within the support layer pore channels 108, which extend through the support structure between the first major surface 104 and the second major surface 106 of the support structure 102. The active layer 110 can advantageously be permselective for one or more species, such as H₂.

AAO advantageously may have substantially parallel and uniform pore channels 108 extending through the thickness of the AAO structure, and the pore channels may have essentially the same diameter along the pore length (e.g., as illustrated in FIG. 1). The pore diameter of the support layer pore channels 108 can be at least about 1 nm, such as at least about 5 nm, and can range up to about 1000 nm, preferably not greater than about 300 nm. Such membranes including AAO structures where the pore channels 108 have a substantially uniform diameter through the thickness of the AAO structures are referred to herein as symmetric pore membranes as shown in FIG. 1.

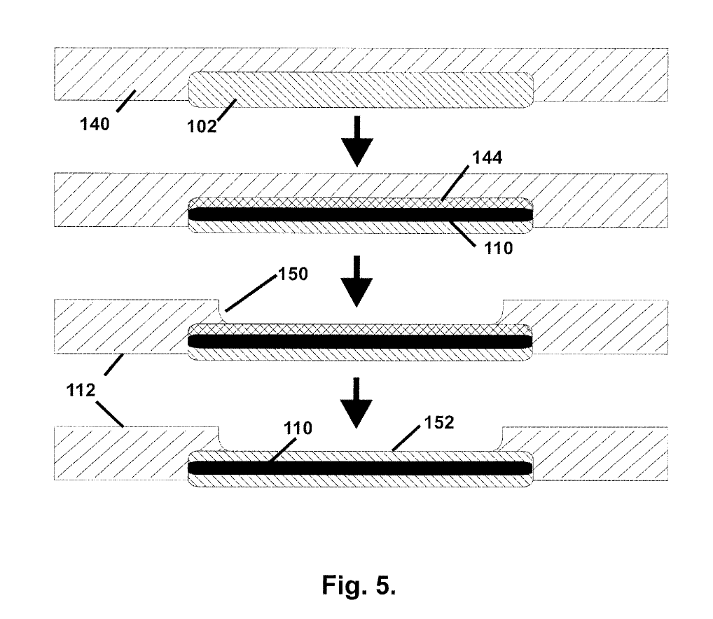

The thickness of the AAO structure 102 may be at least about 0.1 μm, such as at least about 10 μm, and can range up to about 2000 μm, such as up to about 200 μm. In one embodiment, the membrane 100 is a free-standing membrane and the AAO support structure thickness is from about 10 μm to about 2000 μm. The membrane may also include an Al rim 112, such as one that is attached to a peripheral edge of the support 102, as is illustrated in FIG. 1, and is further illustrated in FIG. 5. The thickness of the AAO structure including an Al rim may be at least about 0.1 μm and not greater than about 5000 μm, for example.

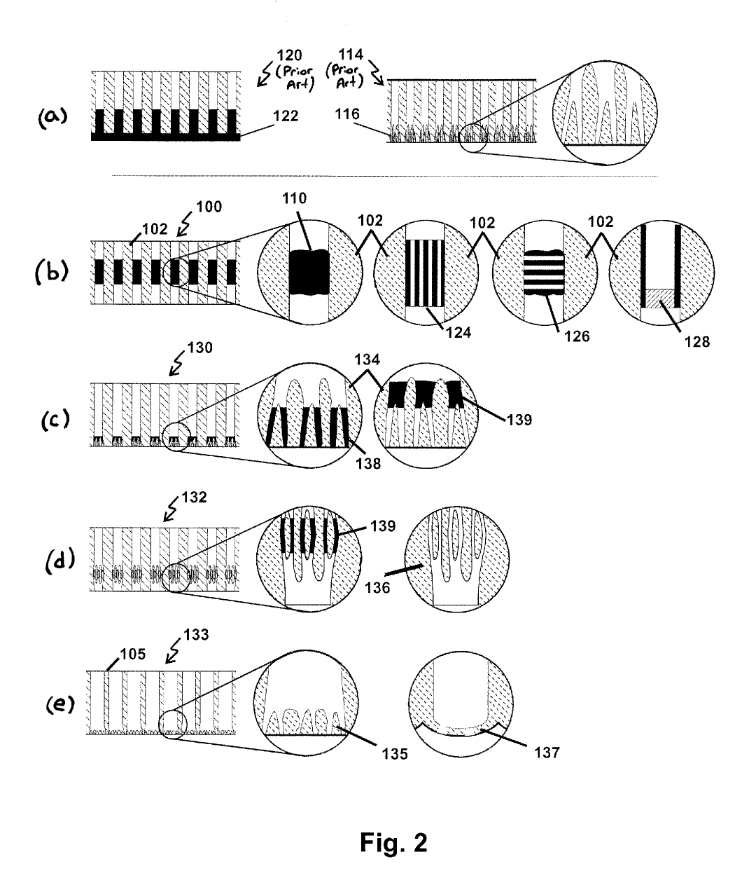

In another embodiment of the present invention, the membrane is an asymmetric pore membrane 130, such as the asymmetric pore membranes illustrated schematically in FIGS. 2(c) to 2(e). According to this embodiment, the AAO structure includes a support layer having relatively large support layer pore channels and a high porosity to maximize overall flux. Accordingly, in one embodiment at least about 50% of the total thickness and not greater than about 99.99% of the total thickness of the AAO structure comprises a support layer having a relatively large diameter pore channels. The total thickness of the support layer can be at least about 1 μm and not greater than about 2000 μm, and the average support layer pore channel diameter can be at least about 10 nm, preferably at least about 50 nm, and not greater than about 500 nm, such as not greater than about 300 nm. The porosity of the support layer is preferably at least about 10%, more preferably at least about 20%, and preferably is not greater than about 80%.

In the asymmetric pore membranes, the active layer may include active layer pore channels having a second pore diameter that is less than the first pore diameter of the support layer pore channels. In this regard, the active layer 134 (FIG. 2(c)) may have an average pore channel diameter preferably not greater than about 100 nm and more preferably not greater than about 50 nm. However, for most applications the active layer pore diameter should be at least about 1 nm. The active layer may include active layer pore channels disposed adjacent to and in operative communication (e.g., fluid communication) with the support layer pore channels. The active layer may have a thickness that is not greater than about 50 μm, preferably not greater than about 25 μm and even more preferably not greater than about 1 μm. For many applications, the thickness of the active layer is preferably at least about 0.001 μm. The smaller pore channel diameter in the active layer may enable reliable encapsulation of nanoplugs, nanotubes or nanoparticles of reduced size, in turn enabling a thin (e.g., as low as about 1 μm, and even as low as 0.001 μm) yet substantially defect-free active layer, further increasing permeability, while maintaining high permselectivity.

The active layer according to one embodiment comprises active layer materials that have the desired permeation and/or separation properties defined by their composition, structure, morphology or all of the above, as illustrated for example in FIGS. 2(b) to 2(d). The active layer materials may be disposed within the pore channels of the AAO structure in a variety of architectures, depending on specific embodiments, and can take the form of dense nanoscale plugs closing the pore channels (e.g., nanoplugs 110 in FIG. 2(b)), conformal nanoscale coatings on the pore walls (e.g., nanotubes), different coatings serving different functions and disposed in parallel relation relative to the pore axis (e.g., nanoplug 124 in FIG. 2(b)) or perpendicular to the pore axis (e.g., nanoplug 126 in FIG. 2(b)). An assembly of separate nanoparticles or other types of nanostructures can also be utilized as an active layer material. According to one aspect of the present invention, the membranes are different from the prior art membranes 120 shown in FIG. 2(a), where an active layer material 122 is disposed partly or completely on the surface of the AAO support membrane.

According to other embodiments, the active layer, such as active layers 135 in FIG. 2(e), active layer 137 in FIG. 2(c), or active layer 136 in FIG. 2(d), comprises active layer pore channels that do not have active layer materials deposited within the pore channels. That is, the reduced pore channel diameter in the active layer performs, e.g., the separation function.

According to one embodiment of the present invention, when the active layer comprises an active layer material, different materials can be utilized for the active layer material depending upon the targeted application of the membrane. For example, the active layer materials can comprise metals, including metal alloys. Preferred among these are Pd and Pd alloys for H₂ separation. In another example, ceramics and metal oxides such as alumina (Al₂O₃) or silica (SiO₂) can be utilized, particularly for reducing the pore size for size-selective separation, such as ultrafiltration. Catalytic materials, such as ZnO/Cu or others can be utilized for combining catalytic chemical transformation and separation, such as in catalytic membrane-reactors. Polymers such as polyimides can be utilized for olefin/paraffin separation. Salts can also be utilized as an active layer material, such as solid proton electrolytes for H₂ separation or oxygen-conducting solid electrolytes. Carbon nanotubes can be utilized for size-selective separation and water filtration.

More specifically, active layer materials that are particularly useful for H₂ separation can include Pd and Pd alloys. Among the Pd alloys are alloys with Ag, Cu, Ru, Au, Ni, Fe, Si, Mn, Co, Sn, Pb, Y, Ce, and combinations thereof. Metals and alloys other than Pd, such as Ta and Ru can also be utilized. Metal oxides such as SiO₂, zeolites, mixed oxides such as Ba—Ce—Y oxide, polymers and other materials can also be used.

According to one embodiment of the present invention for H₂ separation, the active layer material comprises Pd or a Pd alloy. The Pd alloy can include Cu, particularly 1 mol. % to 99 mol. % Cu, and preferably 30 mol. % to 50 mol. % Cu. In another embodiment, the Pd alloy can include Ag, such as 1 mol. % to 99 mol. % Ag, and preferably 20 mol. % to 40 mol. % Ag.

Other materials that can be utilized for the active layer material include amorphous metal alloys (AMA), also referred to as metal glasses, which have been identified as an alternative to Pd for H₂ separation due to their strength, toughness, corrosion resistance, and ability to form thin films. However, due to lower bulk permeability in comparison with pure Pd, these materials must typically be used as ultra-thin layers to achieve the required H₂ permeability, while maintaining high film integrity and low defect density to sustain the desired selectivity.

All amorphous metal alloys are thermodynamically metastable. When the temperature is increased, the performance of such membranes deteriorates due to gradual crystallization, which affects their practical applications. It is an advantage that the confinement of amorphous metal alloys to small pores in the membranes of the present invention can improve the thermal stability and extend their range of application. For example, the AMA alloys can be selected from Zr—Ni and Ni—B(P). Other amorphous metal alloys include Zr—Ni—Hf, Zr—Ni—B, Zr—Nb—Ni, Ni—Pd—P, Ni—Ru—P, Ti—Fe, Fe—B—Si, Fe—Ni—P—B, (combinations of Y, Ti, Zr and Hf with Fe, Ni, Cu, Rh and Pd), Pd—Si, Pd—Cu—Si, Zr—Pd and others. Amorphous metals and alloys can be produced and deposited by various techniques, including rapid quenching of a melt, thermal evaporation, sputtering, electrodeposition, electroless deposition, ion implantation, mechanical alloying, or by hydrogenating the crystalline alloys.

The active layer materials can be deposited within the AAO structure as nanoplugs, nanotubes, nanoparticles or other nanostructures within a pre-determined location (e.g., depth) of the pores of the AAO structure, forming a thin yet robust and substantially defect free active layer. The active layer material can have a high permeability, high permselectivity and increased robustness that cannot be achieved with conventional supported membranes.

Deposition methods for the active layer material can include, but are not limited to, electrochemical deposition, electroless deposition, sol-gel deposition, solution impregnation, melt impregnation, polymerization, chemical vapor deposition, atomic layer deposition, plasma sputtering, thermal evaporation, vacuum deposition, and other methods known to those skilled in the art.

According to one embodiment, the active layer material 139 (FIGS. 2(c) and 2(d)) is at least partially disposed within the active layer pore channels having the smaller second pore channel diameter 134 or 136. This may advantageously enable the active layer material to have a thickness that is only a fraction of the total thickness of the AAO structure.

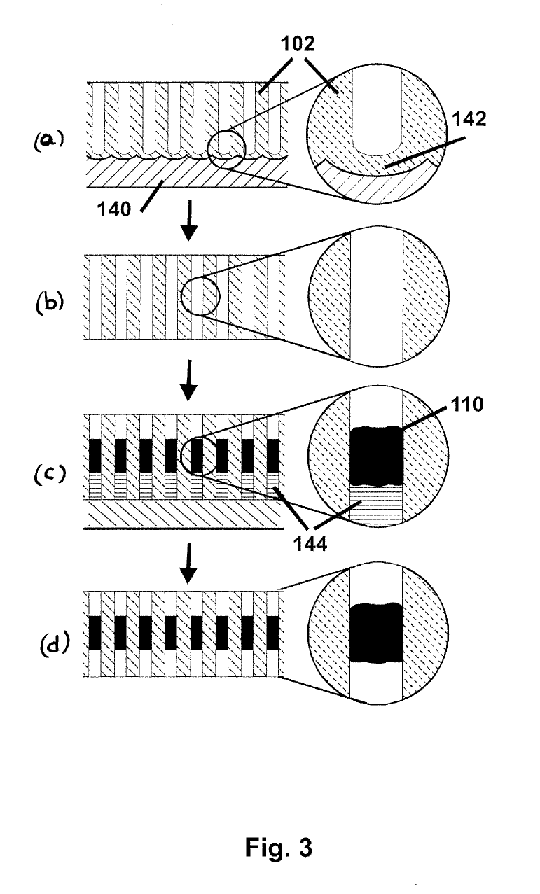

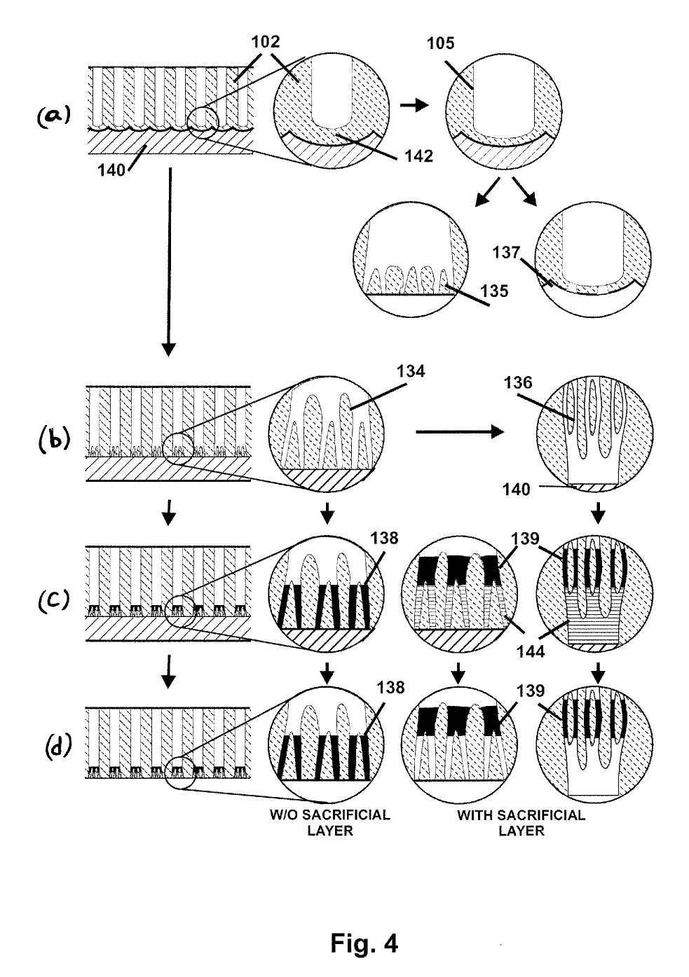

To control the depth of the deposition of the active layer materials within the pore channels, a sacrificial material layer may be used, such as shown schematically in FIG. 3 and FIG. 4. The sacrificial layer 144 may be deposited using any of the methods described above for the active layer material. After deposition of the sacrificial layer 144, the active layer material 110 (FIG. 3) or 139 (FIG. 4) can then be deposited adjacent to the sacrificial layer, followed by selective removal of the sacrificial layer to leave nanostructures of the active layer at a preselected depth within the pore channels of the AAO structure. Materials that can be utilized for the sacrificial layer can include metals, salts, oxides, ceramics, polymers and other materials.

Several materials can be used as a sacrificial layer for a Pd-based active layer. These include metals such as Cu, Zn, Fe, Co, Ni, Ag, In, Sn, Pb, Bi and mixtures thereof, with Cu and Zn being particularly preferred. Metal oxides can also be utilized, particularly Al₂O₃, SiO₂, TiO₂ and ZnO, with ZnO being particularly preferred. Further, polymers, and in particular conducting polymers, can also be used.

As shown in FIG. 3, one group of preferred methods for the fabrication of membranes for H₂ separation involves separation of the AAO structure 102 from its originating Al substrate 140, followed by deposition of conductive contacts and sacrificial Cu 144 onto the face of the AAO structure, followed by electrodeposition of Pd to form an active layer 110 within the pores. Another method shown in FIG. 4 can utilize the Al foil 140 as an electrical contact for electrodeposition of both the sacrificial Cu layer and the Pd active layer.

According to one embodiment illustrated schematically in FIG. 5, the fabrication method provides the fabrication of membranes with an integrated Al rim 112. Using a similar approach, another method provides fabrication of tubular membranes with integrated Al ends.

In another embodiment, a membrane, shown in FIG. 4, includes a porous support layer 102 and an adjacent active layer with smaller pores 135. Depending on the pore size, the active layer 135 can advantageously be permselective for one or more particulates, molecules, ions or other species in gaseous or liquid media. For most ultra- and nanofiltration applications the pore channel diameter in the active layer 135 may be at least 0.2 nm and not greater than about 20 nm, such as not greater than about 15 nm, or even not greater than about 10 nm. To control the location of the active layer with smaller pore channels (135, 136), sequential anodization steps in different conditions can be used, as described herein.

### Support Structure and Method of its Fabrication

The present invention includes the use of a porous AAO structure formed by anodization (electrochemical oxidation) of aluminum (Al). A method for the fabrication of AAO is described, for example, in U.S. Pat. No. 6,705,152 by Routkevitch et al., which is incorporated herein by reference in its entirety.

According to one embodiment of the present invention, prior to anodization to form the AAO, the Al foil substrate may be prepared for anodization. For example, the Al foil may be cut and rolled to reduce the thickness of the Al foil to a thickness of not greater than about 80% of the original thickness. After reducing the thickness, the Al foil may be annealed, such as at a temperature of at least about 200° C. and more preferably at least about 350° C. The annealing is preferably a pressure-anneal, where the pressure during annealing is above atmospheric pressure, such as a pressure of at least about 5,000 psi, and preferably not greater than about 20,000 psi, more preferably not greater than about 10,000 psi. It has been found that this rolling and pressure-annealing treatment may advantageously result in an Al foil having the desired thickness, surface quality and crystalline structure (from non-textured nanocrystalline structure to highly textured structure with large grain size) in order to produce AAO structures suitable to specific uses.

The resulting Al foil may be cleaned and optionally pre-anodized to form an AAO surface layer, such as an AAO surface layer having a thickness of from about 1 μm to about 100 μm. The AAO surface layer may then be selectively dissolved to remove the surface layer, which may include defects, and to provide an Al foil surface pre-patterned with pore channel indents.

The Al foil substrate may then be patterned or masked on one or both sides, such as by using photoresist, tape, varnish, compression gaskets, or similar means. The patterning may define the size and shape of the subsequently formed AAO structure.

According to one embodiment, in order to avoid dielectric breakdown and to enable rapid application of the anodization voltage (e.g., a relatively high voltage of greater than 200 V) to the Al substrate, thus forming AAO with a desired pore period rapidly after starting anodization, a dense non-porous oxide layer may be formed on the Al substrate surface prior to high voltage anodization. This dense oxide layer may be formed at a voltage equal to or lower than the final anodization voltage, but preferably at a voltage not lower than about 25% of the final anodization voltage. The Al foil can then be anodized to form the structure having the desired AAO structure thickness and pore diameter.

Anodization of an Al foil substrate to form AAO structures with a pore channel diameter of from 20 nm to about 200 nm is a process known to those skilled in the art. The present invention advantageously provides a method for the fabrication of AAO structures with active layer pore channel diameters below 20 nm, such as below 10 nm, and even below 5 nm. In one embodiment, the method entails the use of diluted electrolytes at reduced temperatures, such as below about 0° C., to form reduced pore diameters.

According to another embodiment, the present invention advantageously provides a method for the fabrication of AAO structures with support layer pore channel diameters greater than about 200 nm. The method may include the use of an electrolyte component that allows anodization voltages in excess of about 200V during anodization, and up to about 1000V, such as up to about 600V. In this regard, an electrolyte component can be selected from the group consisting of: (i) metal salts of a pore forming electrolyte acid such as oxalic acid, sulfuric acid, phosphoric acid, citric acid and malonic acid, such as aluminum oxalate, aluminum sulfate, aluminum phosphate, aluminum citrate or aluminum malonate; (ii) a non-pore forming electrolyte such as boric acid, sodium borate, ammonium phosphate, ammonium borate, ammonium adipate and ammonium oxalate; and (iii) an organic polar solvent, such as an alcohol or ketone.

When the electrolyte component comprises a metal salt of the pore forming electrolyte acid, the metal salt may comprise an oxalate salt, for example. Further, the metal salt may include a complex salt, the complex salt comprising at least a first cation selected from Group I or Group II elements and at least a second cation selected from Group III or Group IV elements. For example, the first cation of the complex salt may be selected from potassium, calcium and magnesium, and the second cation of the complex salt may be selected from aluminum and titanium.

When the electrolyte comprises a non-pore forming compound selected from the group consisting of boric acid, sodium borate, ammonium borate, ammonium phosphate, ammonium oxalate and ammonium adipate, the electrolyte may also include a pore forming electrolyte acid, such as one selected from the group consisting of oxalic acid, sulfuric acid, phosphoric acid, citric acid, malonic acid and mixtures thereof.

Anodization at high voltage may provide an AAO structure with a large pore period (i.e., average distance between the pore centers) in the support layer. To increase the pore diameter to the desired value, an AAO structure formed at high anodization voltage may be chemically etched.

Table 1 illustrates representative ranges of anodization conditions that may be used to produce AAO structures, and the resulting support parameters in accordance with the present invention.

Both potentiostatic and galvanostatic modes of anodization can be utilized to form the AAO structure. Potentiostatic mode can ensure substantially uniform pore diameter through the thickness of the structure, with anodization current density and AAO growth rate decreasing with time. On the other hand, galvanostatic mode maintains a constant growth rate, thus ensuring shorter process duration while allowing the voltage (and the pore diameter) to increase with time.

TABLE 1

| | Voltage or | | Temp. | Charge | Pore dia., nm/ | Thickness |
|---|---|---|---|---|---|---|
| Electrolyte | Current | | (° C.) | (C/cm²) | Porosity, % | (μm) |
| 0.01-5% | 5-100 | V | −5/+25 | 2-1000 | 8-80/10-15 | 1-500 |
| H₂C₂O₄ | 1-50 | mA/cm² | | | | |
| 0.01-5% | 100-600 | V | −5/+25 | 2-1000 | 100-600/10-30 | 1-500 |
| H₂C₂O₄ + | | | | | (up to 1000 nm | |
| additives** | | | | | with additional | |
| | | | | | pore etching) | |
| 0.01-3M | 5-25 | V | −5/+25 | 2-1000 | 10-20/7-18 | 1-500 |
| H₂SO₄ | | | | | | |
| 0.01-3M | 5-25 | V | −50/+25 | 2-1000 | 5-15/5-15 | 1-500 |
| H₂SO₄* | | | | | | |
| 0.01-3M | 10-200 | V | −5/+25 | 2-1000 | 30-200/7-20 | 1-500 |
| H₃PO₃ | | | | | | |

*alcohols, ketones, glycols, or other solvents added to lower the freezing point.
**additives to increase anodization voltage include salts of certain metal cations (such as Al(III), Ti(IV), V(V), Zr(IV), Nb(V), K(I) and others; anions of organic and inorganic acids including those used in anodization electrolytes (such as oxalate, citrate, borate, malate and others), as well as metal complexes with other ligands (such as K₂[TiO(C₂O₄)₂]).

### Methods of Forming Thick AAO Structures

The present invention also includes a method of making AAO structures with thickness up to 2 mm, such as up to 5 mm or greater, enabled by protecting the AAO from dissolution in the electrolyte during prolonged anodization.

The method may include (i) anodizing Al to grow a first AAO layer, (ii) applying a protective coating over at least a portion of the first AAO layer to protect the first layer from gradual dissolution in the anodization electrolyte, where the protective layer may be a thin (e.g., 1 nm to 5 nm thick) and conformal protective coating that is insoluble in the anodization electrolyte, but may be breached electrochemically at the bottom of the pore channel during anodization, and that may be etched selectively without substantially affecting the remaining anodic alumina, where the coating may be polymer, metal oxide, or self-assembled monolayer, such as of material(s) that do not substantially dissolve in anodization electrolyte for the duration of the anodization. Methods for applying the protective coating may include liquid phase (e.g., dip-coating, spin-coating, spray-coating, etc) or gas phase (e.g., chemical vapor deposition, atomic layer deposition, physical vapor deposition, etc.), preferably dip-coating, (iii) continuing anodization to form a second AAO layer. The method may also include the further step of (iv) depositing a further protective layer onto newly grown AAO layer, which may involve removal of the previously deposited protective layer by selective chemical dissolution followed by re-depositing a protecting layer again, and (v) repeating the steps (i)-(iv) to grow an AAO structure with a thickness greater than can be obtained in continuous (e.g., 1-step) anodization.

Protecting a portion of the AAO structure can also be applied during forming of the active layer(s).

Methods of Forming Active Layers and Separation of AAO Structure from Al

After formation, the AAO structure is still attached to the Al substrate 140 as shown in FIG. 3 and FIG. 4, and have a dense aluminum oxide layer 142 (e.g., a barrier layer) separating the porous AAO from the Al substrate. In order to make a functional membrane, this barrier layer 142 has to be breached and an active layer has to be formed. The breaching of the barrier layer may be done either prior to the deposition of the materials into the membrane pores to form the active layer as illustrated in FIG. 3 and in FIG. 4, or after the material deposition into the pores of the active layer as illustrated in FIG. 4, as is described herein.

If the separation of the AAO structure is required prior to deposition of an active layer material, this process may be carried out after the anodization, and involves electrochemical polarization of the AAO on the Al substrate using acidic electrolytes such as phosphoric acid or hydrochloric acid, or using basic electrolytes such as sodium hydroxide or potassium hydroxide. This process leads to localized dissolution or “breach” of the barrier layer due to the effect of anodic or cathodic bias and results in free-standing membranes with pores that open on both faces.

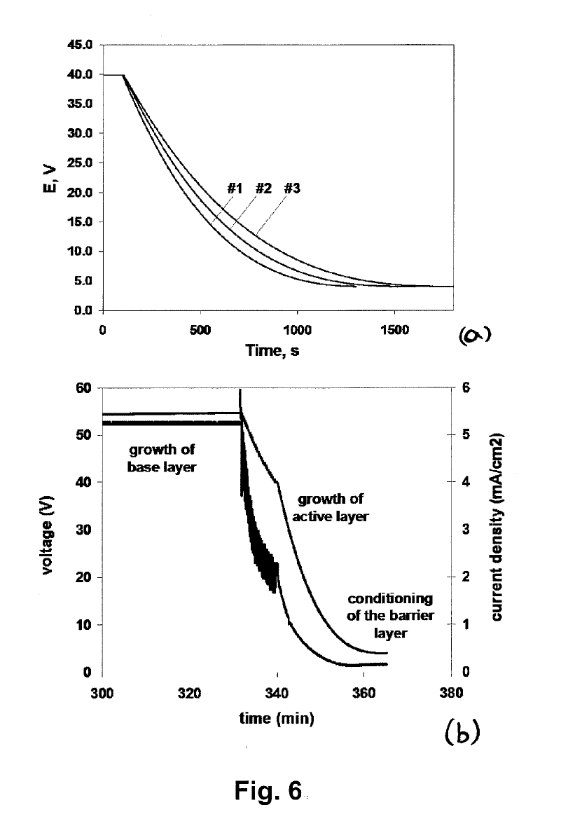

The procedure for fabrication of an asymmetric AAO structure for an asymmetric pore membrane may involve a three-step anodization method. Referring to FIG. 4, the steps may include: (1) growth of the support layer 102 at a constant current or voltage to form the desired thickness and desired first (larger) support layer pore diameter; (2) optional conformal pore etching to increase the pore diameter of the support layer 105, (3) reduction of the anodization voltage (e.g., as shown in FIG. 6) using a smooth voltage-time profile to form an active layer (e.g., active layer 134, 135 or 136) with smaller active layer pore channel diameters, where the pore diameter and the barrier layer thickness are decreased proportionally to the anodization voltage; and (4) a current recovery step at constant voltage to form uniform pore channels of desired size in the active layer, and to condition the barrier layer, and (5) an optional deposition of an active layer material (e.g., Pd via electrodeposition) results in a uniform active layer, such as for H₂ separation.

Alternatively, the current recovery step in the above procedure may be omitted. In this other embodiment, the active layer 134 or 135, without deposition of an active layer material, may be useful for size-based separation (e.g., such as for ultrafiltration and nanofiltration). Utilizing the voltage reduction profile of step 3 may maximize the rate of voltage reduction, yet sustain anodization current and therefore sustain continuous pore growth. Thus, the thickness of the active layer can advantageously be reduced. This active layer may have a high permeability, high permselectivity and increased robustness that cannot be achieved with conventional membranes.

In yet another embodiment, omitting the steps of anodization voltage reduction and current recovery of constant voltage may allow the dense barrier layer 142 of AAO to comprise one of the components, or the only component, of the active layer 137. To achieve desired performance, the barrier layer may be selectively breached to form one or more smaller pores (e.g., pore channel diameter of less than 20 nm) as shown in FIG. 4. This partial breaching of the barrier layer can be performed by electrochemically removing a portion of the barrier layer, e.g., by applying a cathodic potential to the Al substrate as described below in Example 5, which forms an active layer 137 as shown in FIG. 4. Alternatively, the barrier layer may be chemically converted into an active layer with desired permselectivity.

Steps 1 through 4 above can be repeated to create multiple active layers with different pore channel diameters and pore densities. According to the present invention, continuous anodization voltage reduction profiles (Step 3 above) may be used to increase the rate of formation of the active layer(s) with smaller pore diameter and density and to better control the morphology in such active layer(s).

According to one embodiment of the present invention, the shape of the anodization voltage profile for forming reduced pore channel diameters and a thinner barrier layer (Step 3), and the current recovery profile to maximize the deposition uniformity (Step 4) may be based on a 3rd degree polynomial used to calculate the voltage-time (E-t) profile:

E=at³+bt²+ct+d

The initial anodization voltage (E1) and final anodization voltage (E2) are used as boundary conditions and are selected from available ranges of anodization conditions shown in Table 1. Adjustable parameters may include the initial (dE/dt)₁ and the final (dE/dt)₂ potential change rate, and the profile duration (t2−t1). The initial potential slope can be varied from about −50 V/s to about −0.005V/min, and preferably from about −1V/s to about 1V/min. The final potential rate change can be from about −50 V/s to about 0 V/s, preferably from about −10V/min to about 0. The duration of the voltage reduction step depends on the voltage change range and desired pore profile, and can vary from about 1 second to several hours.

In one example, 5% oxalic acid electrolyte may be used for both the synthesis of the support layer (galvanostatic mode, 5 mA/cm², final anodization voltage (E1) of 40V, corresponding to a pore channel diameter of about 37 nm), as well as for the formation of the active layer (voltage (E2) reduced to 4V, corresponding to a pore channel diameter of about 5 nm). The first voltage derivative and the process duration are varied, and the second derivative is set to 0.

Representative voltage reduction anodization profiles are illustrated in FIG. 6(a). One preferred profile for anodization voltage reduction from 40 V to 4 V is found to be (dE/dt)1=−0.0070 V/s and t2=1500 s. The resulting anodization profile for the entire process (growth of the base layer, forming an active layer and conditioning the barrier layer) is illustrated in FIG. 6(b). Scanning electron microscope (SEM) images of the resulting asymmetric membrane after electrochemical separation from Al (performed substantially as described in U.S. Pat. No. 6,705,152 by Routkevitch et al.) show a uniform pore channel diameter in the support layer and a smooth, homogeneous and defect-free surface of the active layer. Permeability data confirm that the pores are open.

In yet another embodiment, the entire anodic alumina structure or just the barrier layer or just the active layer can be chemically converted into a different material in gas phase or solution-based reactions to form membrane of desired composition.

In one embodiment, the pore channel diameter of the AAO structure can be increased by conformal etching (e.g., dissolution) of alumina from the pore walls in appropriate acidic or basic solutions, such as phosphoric acid, sodium hydroxide, potassium hydroxide, or other solutions that can dissolve alumina. Preferred embodiments may include the use of 0.5M H₃PO₄ or 0.1 M NaOH at temperatures in the range of 0° C. to 50° C. Preferred etching times depend upon the desired initial and final pore channel diameter and the temperature, and can vary from about 10 seconds to about 5 hours, preferably from about 5 min to about 300 min.

In one embodiment, the pore channel diameter of the support layer or the active layer may be reduced by conformal deposition of materials onto the pore walls. In another embodiment of the present invention, additional active layer materials may be deposited to fully close the pores and form an active layer 110 or 138 or 139 including the active layer material. Methods for conformal deposition can include sol-gel, solution impregnation, polymerization, electroless deposition, electrochemical deposition, solution impregnation, chemical vapor deposition, atomic layer deposition and others methods know to those skilled in the art. One preferred embodiment involves atomic layer deposition of oxides, such as alumina, silica, zinc oxide, and other materials.

In H₂ separation membranes, Pd or Pd alloys may be used as an active layer material, and Cu may be used as an optional sacrificial layer. Both Pd and Cu may be deposited inside the pore channels of an AAO support using electrolytes, forming an active layer having dense nanoplugs disposed within the pores of the support. Both conventional “DC” electrodeposition methods (potentiostatic and galvanostatic) as well as “pulse” and “AC” techniques may be used.

For the fabrication of membranes with active layer materials disposed within the pores of the support structure and not on the membrane surface (e.g., as shown in FIG. 3) the electrical contact to the pores can be provided by a dense film of conductive material, such as a metal, deposited onto one face of the support. In one embodiment, the conductive film may be a Cu film, such as one having a thickness of at least about 100 nm and not greater than about 2000 nm. Such a film can be deposited onto a face of the membrane by DC plasma sputtering, for example. Galvanostatic deposition (DC mode, current density inside the pores of from about −1 to about −5 mA/cm²) is one preferred method for fabricating symmetric support structures with a Cu contact to form a sacrificial conductive film 144.

For the fabrication of an active layer having an active layer material close to the membrane surface as shown in FIG. 4, the contact can be provided by the Al substrate. In this case, the deposition may be hindered by the presence of a dense oxide layer at the interface between the support and the Al foil. This insulating layer may prevent the use of conventional electrodeposition methods. The preferred methods in this case may include pulse, reverse pulse, and AC potential waveform with a DC offset.

The main electrodeposition parameters that define the length and the uniformity of the nanoplugs of active layer material in the active layer are the electrolyte composition, the temperature, the deposition mode, the waveform, the potential, the current density and the time. These parameters are selected based on the type of AAO structure and desired active layer morphology. Other factors affecting the uniformity and the rate of the deposition of the active layer material include the shape and duration of the voltage reduction profile during the step of the conditioning of the barrier layer for asymmetric pore membranes with Al as a contact. A proper combination of these parameters can lead to the electrodeposition of fully dense and conformal nanoplugs inside AAO pore channels.

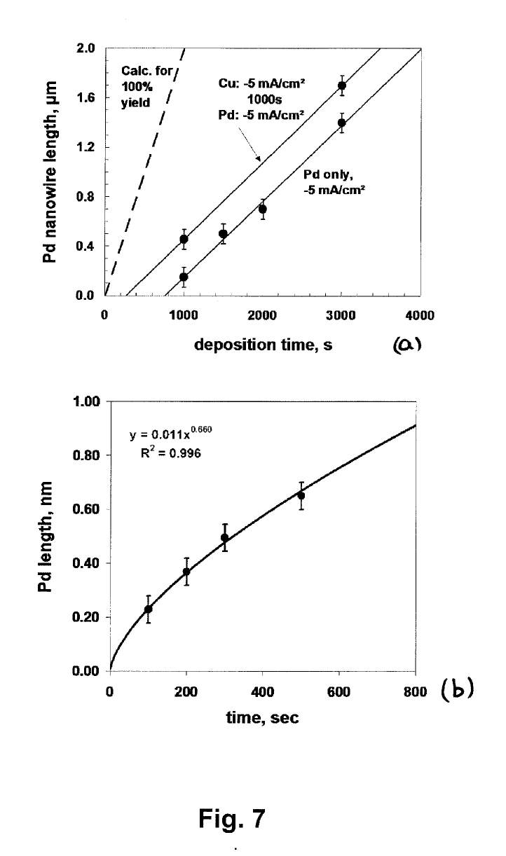

One embodiment of the present invention utilizes a 20 Hz to 100 Hz sine potential waveform having amplitude from ±1V to ±15V, which can depend upon E2. In one embodiment, E2=4V, and the preferred amplitude is ±9V. The DC offset can be from 0 to ±10V, and in one example for E2=4 V, the preferred DC offset is −1V. The duration of deposition can be from 1 second to several hours, with the length of nanoplugs (thickness of the active layer material) generally increasing with the deposition time, as shown in FIG. 7. The preferred duration of deposition of the Cu sacrificial layer is from about 100 s to about 5000 s, forming Cu nanoplugs having a length of from 0.2 μm to 10 μm. A preferred duration of Pd active layer deposition is from about 200 s to about 4,000 s, which may result in Pd nanoplugs having a length from about 100 nm to about 1 μm, which is significantly thinner than the Pd film thickness utilized in conventional membranes.

Accordingly, electrodeposition can be used to place sacrificial Cu nanoplugs at the bottom of the AAO pore channels, which can be used to localize Pd nanoplugs at a desired distance from the membrane surface (FIG. 3, FIG. 4, top chart in FIG. 7).

The sacrificial Cu layer can be removed from the support using known liquid or gas phase methods for Cu metal etching. For example, an ammonium persulfate (APS) etch, or a solution of sulfuric acid and hydrogen peroxide (Piranha etch) can be utilized to remove the Cu sacrificial layer. Thus, control of the location of the active layer, such as Pd, within the membrane support can be achieved by using sacrificial nanoplugs, such as Cu, of varying length.

The present invention includes several methods to form an active layer material from Pd alloys. One preferred method is electrochemical co-deposition of Pd and another metal, such as Cu or Ag, from mixed electrolytes containing ionic species of both Pd and the other metal. The alloy composition may be determined by the partial current densities, which depend on deposition potential and the electrolyte composition.

According to another embodiment of the present invention, a method is provided that includes annealing of a porous support containing two or more metals, such as Pd and Cu, that have been consecutively deposited to form an alloy phase between the metals. The alloy composition of the annealed active layer material can be controlled by varying the length of the metal nanoplugs, along with varying the annealing temperature and the anneal duration. This approach may provide a convenient route for fabricating a membrane from alloys such as Pd—Cu and Pd—Ag alloys, and is also useful for the fabrication of other alloys. The annealing temperature may be at least about 200° C. and is preferably not greater than about 1600° C., such as from about 500° C. to about 1000° C. The annealing atmosphere can be varied and can include reducing or oxidizing atmospheres, as well as otherwise inert or reactive atmospheres. Proper selection of the annealing atmosphere can be used to improve the performance of the active layer material due to changes in the chemical composition and the crystalline structure of the active layer material. The deposition method for the consecutive metal layers can include sol-gel, solution impregnation, chemical vapor deposition, atomic layer deposition and other methods.

According to another embodiment of the present invention, consecutive deposition of different materials and/or different methods as described above can be used to form multiple layers of active material, or to implement layers having multiple functionality, as shown in FIG. 2. In one embodiment for H₂ separation, the multilayer structure includes a poison-resistant layer, such as Ta for resistance to sulfur, on top of a H₂-separating layer based on Pd or Pd alloys. Another preferred embodiment includes a conformal coating of an appropriate catalyst such as Cu/ZnO to form catalytic nanotubes adapted to catalyze a steam reformation or water gas shift reaction. Dense nanoplugs of Pd or Pd alloys or other materials described herein, serving a catalytic function or a H₂ separation function, can form a nanochannel array membrane-reactor for converting alcohols or hydrocarbons into H₂. Such catalytic coatings as Cu/ZnO can be deposited by sol-gel or atomic/chemical vapor deposition.

For operation above about 750° C. in the gas phase, or for prolonged exposure to aqueous solutions, or to increase the range of pH where membrane can operate, the AAO structure can be annealed, such as at about 700° C. to 1200° C., prior to or after the deposition of an active layer material, to convert amorphous alumina into a thermally stable polycrystalline gamma- or alpha-alumina phase.

### Fabricating a Membrane Having a Metal Rim

According to one embodiment, the present invention also provides a method for the fabrication of a membrane including an AAO structure having an Al rim as shown in FIG. 5. Such a structure is advantageous, as it enables an AAO-based device, such as membranes, to be sealed into an apparatus incorporating the device.

After forming an optional sacrificial layer 144, and an active material layer 110 inside the pore channels of an AAO structure, three additional processing steps (FIG. 5) may be carried out to fabricate the structure with an Al rim 112:

1) Etching of Al substrate 140 to open a window 150 in Al;

2) Etching of the barrier layer 142 to provide access to the active layer; and

3) Etching of the sacrificial layer 144, if a sacrificial layer is used.

In one embodiment, the first two steps are performed before placing the active layer material in the AAO structure.

For the Al etching step, the back side of an Al foil substrate with an attached AAO structure is masked with a chemically resistive pattern, such as by using a photoresist, lacquer or tape, or is patterned with a chemically inert gasket or O-ring, to expose an Al area 150 of the desired size. A wet chemical etch that does not react with the AAO, such as a solution of hydrochloric acid (HCl) and copper chloride (CuCl₂), is used to dissolve the Al and expose the AAO structure. The etching of Al effectively stops when the AAO surface is reached.

If the AAO support is formed without removal of the dense barrier layer before etching Al, the barrier layer 142 has to be breached. This process is critical for maximizing membrane permeability, while avoiding overetching of the membrane and maintaining substantially zero defect density. Etching can take place using appropriate acidic or basic solutions that can dissolve alumina, such as phosphoric acid, sodium hydroxide or potassium hydroxide. In a preferred embodiment, the alumina barrier layer may be etched with 0.5M H₃PO₄ or 0.1M NaOH at a temperature in the range of from about 0° C. to about 50° C. The preferred etching time depends on the barrier layer thickness and etching temperature, and may vary from about 10 s to about 2 hrs for example. Etching of the barrier layer may also be performed in a gas phase using, for example, a plasma ion etch.

Etching of the sacrificial layer 144 can be performed using common wet or gas phase methods known to those skilled in the art, depending on the materials used as a sacrificial layer. In one preferred embodiment, solution of ammonium persulfate or Piranha etch may be used for etching a copper sacrificial layer.

According to one embodiment, a portion of the AAO structure remains attached to the Al by exposing only the central portion of the AAO structure 152 to the barrier layer breaching step, without separating the rest of the AAO structure. Selective back-etch of the Al substrate can then be performed to expose the central portion of the AAO structure 152, with the rest of the AAO remaining attached to an Al rim.

In another embodiment, a window 150 in the Al foil is etched prior to breaching of the barrier layer or prior to creating an active layer with smaller pores or different active layer materials, followed by chemical or electrochemical breaching of the barrier layer to create support structure 110 or by chemical or electrochemical breaching opening of select pores in the barrier layer to form a thin active layer.

### EXAMPLES

Having described the invention, the following examples are given to further illustrate the invention. These specific examples are not intended to limit the scope of the invention described in this application.

### Example 1

### Free-Standing AAO Structures

AAO structures are formed by anodizing 99.99% pure Al foil that is rolled and pressure-annealed at 350° C. and 5,000 psi for 20 min. The resulting Al foil is cleaned and anodized on both sides in 1% oxalic acid electrolyte at a temperature of 10° C. and an anodization current density of 10 mA/cm², until a charge density of 20 C/cm² is accumulated. The resulting layer of aluminum oxide is then etched out using a hot solution of 200 g/l chromic oxide in 50% phosphoric acid, the Al substrate is rinsed and dried, and an adhesion layer of 0.5 μm of AAO is grown using the same conditions.

Conventional photoresist is applied to both sides of the Al substrate, is soft-baked at 90° C. for 20 min and is exposed to a UV light using a mask with the openings of required size and format to define the number, the location, the size and the format of the membranes—in this case, four 25 mm circular membranes on each side of a 70 mm×70 mm substrate. Final anodization is carried out in 1% oxalic acid electrolyte at temperature of 10° C. and anodization voltage of 80V until charge density of 100 C/cm² is accumulated, corresponding to a 50 μm thick AAO support structure with a pore diameter of about 65 nm and a porosity of about 12%.

Voltage reduction profile #2 (FIG. 6(a)) is applied to some of the Al substrates to transform the existing barrier layer into a porous AAO layer with smaller final pore diameter than was obtained during anodization at 80V. The anodization voltage is reduced to 20V and the anodization is continued for another 100 seconds, resulting in a final pore diameter of about 18 nm. Some of these Al substrates are rinsed and transferred into a 1M solution of sulfuric acid, where anodization is re-started at 20V, and a different voltage reduction profile is applied to bring the anodization voltage to 2V, resulting in a final pore diameter of less than 5 nm and a porosity of about 15%.

To form free-standing membranes without an Al rim, both types of AAO structures are separated in a solution of concentrated perchloric acid and acetic anhydride at a cathodic bias of 5 V to 10 V above the final value of anodization voltage. The pore diameter in some of the AAO structures is increased by slow chemical dissolution of the alumina from the pore walls for 20 min in a solution of 0.5M phosphoric acid, resulting in the final pore diameter of about 80 nm. The resulting membranes are rinsed, dried, annealed to 1100° C. to form alpha-alumina, and are then ready for the deposition of active layer materials. Blank AAO structures with overall diameter as large as 150 mm are produced in this example.

### Example 2

### AAO Structure with Large Pore Period and Pore Diameter

Al substrates are prepared as noted in Example 1, except that after forming an adhesion layer of 0.5 μm of porous AAO and applying photoresist mask, the adhesion layer in the exposed area is etched out using a hot solution of 200 g/l chromic oxide in 50% phosphoric acid, the Al substrate is rinsed and the substrate is placed in a non-pore-forming electrolyte (0.1 M boric acid), to form a dense layer of alumina at a voltage equal or lower than the final anodization voltage, but no less that 25% of the final anodization voltage. This dense layer is required to achieve the final anodization voltage rapidly in the beginning of the final anodization step, and ensures the creation if the required pore period throughout the entire AAO structure.

Final anodization is carried out in a high voltage electrolyte (1% oxalic acid with one of the additives listed in Table 1) at a temperature of 0° C. to 2° C. and an anodization voltage of 600 V, resulting in an average pore period of 1 μm to 1.2 μm and an average pore diameter of 0.1 μm to 0.2 μm. The AAO structure can be optionally separated from the Al substrate similar to Example 1 to form a free-standing AAO structure, with the pore channels fully open at one surface of the AAO structure and partially open pores on the other (opposed) surface of the AAO structure. To achieve larger pore diameter, the AAO structures (either attached to the Al substrate or free-standing) are etched for 180 min in 0.5M phosphoric acid at 35° C., resulting in pores with a diameter of 0.4 μm to 0.6 μm. In the free-standing AAO structure the resulting pores are fully open on both surfaces.

### Example 3

### AAO Membranes with an Al Rim

AAO support structures are produced using Al foil prepared and patterned as described in Example 1, except only one side of the Al substrate is anodized. Anodization is carried out in 3% oxalic acid electrolyte at a temperature of 12° C. and an anodization voltage of 40V until a charge density of 200 C/cm² is accumulated, resulting in 100 μm thick AAO structures with 37 nm pores. With some Al substrates, voltage reduction profile #2 (FIG. 6(a)) is used to bring the anodization voltage down to 4 V, and anodization is continued for 100 seconds at 4V. The resulting asymmetric AAO structure has a final pore channel diameter of about 5 nm.

The resulting AAO structures, which are still attached to Al, are masked with 3M electroplating tape to define 8 mm circles in the center of the 13 mm structures. The barrier layer in the exposed area is breached in a solution of concentrated hydrochloric acid at −2° C. by slow ramping of the cathodic potential until 3V to 10V above the final value of the anodization voltage is reached. As a result, the barrier layer is breached only in the defined 8 mm area, and the rest of the AAO support remains firmly attached to the Al substrate. A backside of the Al foil opposite the 13 mm AAO is then also masked to define a 10 mm circles opposite to the area where the barrier layer is breached, and exposed Al is etched using a solution of 20% hydrochloric acid and 15% CuCl₂ in water, until the back side of the AAO support is exposed, forming membranes with through porosity and supported by an Al rim. A similar procedure can be applied to form tubular AAO membranes.

Using procedures described in this example, planar membranes integrated onto an Al rim with overall dimensions of up to 10″×20″ are produced.

### Example 4

### Ultrafiltration AAO Membrane with Thin Active Layer

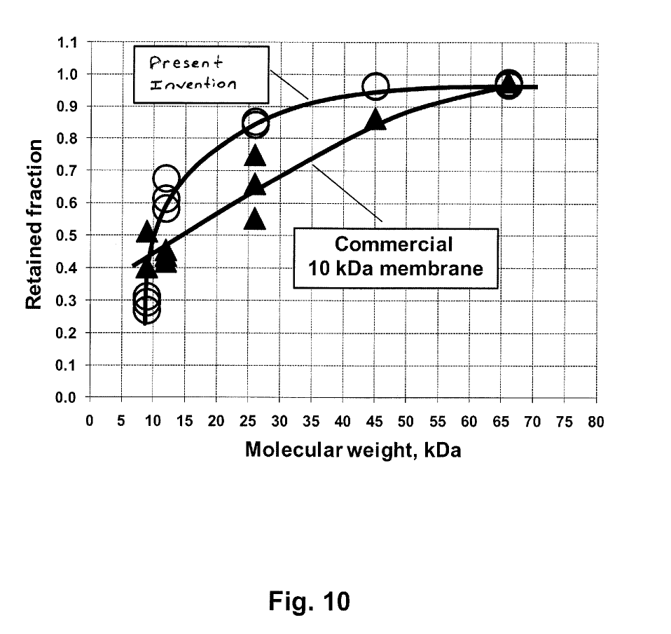

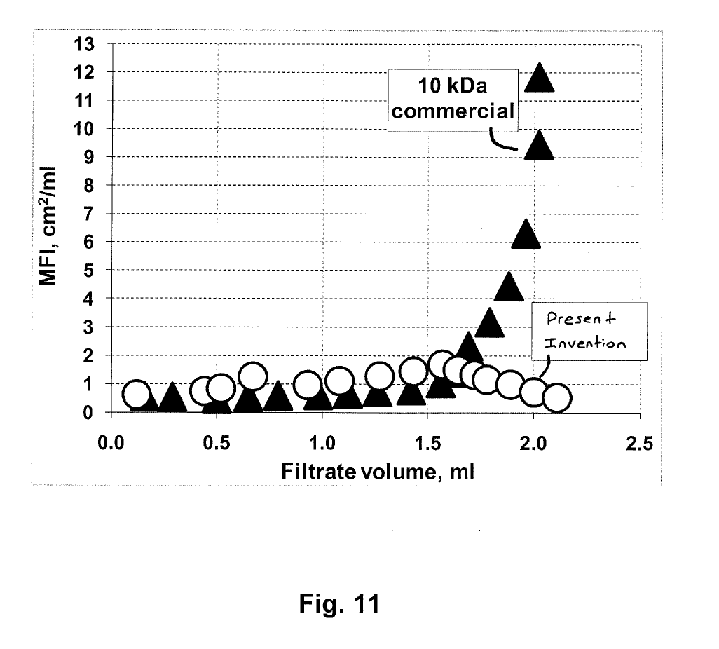

Al substrate preparation is carried out as described in Example 1. An AAO support structure is produced as described in Example 2, except using an anodization voltage of 200 V, resulting in an AAO structure with a pore period of about 500 nm. After first anodization, the pore channels in the support layer are conformally etched for 60 min in 0.5M phosphoric acid to result in a pore channel diameter of 250 nm and a reduced thickness of the barrier layer. The samples are placed into a second anodization electrolyte (3% oxalic acid) and a voltage reduction profile is applied starting at a voltage equal to or less than the anodization voltage and finishing at 2 V. The AAO structure is separated in a manner similar to Example 1. The resulting structure is annealed at 750° C. for 5 hrs to provide long-term stability in aqueous solutions. The membrane has an average pore diameter in the active layer in the range of 4 nm to 6 nm and the active layer thickness is about 0.5 μm. FIG. 10 and FIG. 11 illustrate performance advantages of thus obtained membranes versus analog commercial polymer membranes in ultrafiltration of protein solutions.

### Example 5

### Ultrafiltration AAO Membrane with Thin Active Layer from Barrier Layer

AAO structures are produced as noted in Example 3, excluding the voltage reduction and separation steps. Instead, the AAO structure still on the Al substrate is placed in a solution of concentrated hydrochloric acid and a cathodic ramp is applied on the substrate at a rate of 0.5 V/s. When the voltage reaches a value of about 20V, the AAO structure is separated from the Al substrate. It is observed that the barrier layer is breached with the formation of active layer pores in the barrier layer having a diameter of below about 20 nm. The thus prepared AAO structures are useful as ultrafiltration membranes with the nominal pore channel diameter in the active layer of below about 20 nm and an active layer thickness of less than about 0.1 μm.

### Example 6

### Composite AAO/Pd Membranes with Al Rim for H₂ Separation

Blank AAO membranes on Al foil substrates are produced as previously noted in Example 2, except the process is stopped before masking for breaching of the barrier layer. Electrodeposition of a Cu sacrificial layer is carried out in an aqueous solution of 0.5M CuSO₄ for 1000 seconds in potentiostatic mode using a 100 Hz sinusoidal waveform with an amplitude of ±9V and a DC offset of −0.5V. Electrodeposition of the active layer of Pd nanoplugs is carried out in a commercial PallaSpeed electrolyte (Technic) for 500 seconds in potentiostatic mode using a 100 Hz SINE waveform with an amplitude of ±9V and a DC offset of −0.5V. A backside of the Al foil substrate opposite to the AAO support is masked to define an 8 mm circle and exposed Al is etched using a solution of 20% hydrochloric acid and 15% CuCl₂ in water, until the backside of AAO/Pd/Cu membrane is exposed. The barrier layer is etched for 20 to 30 minutes in a solution of 0.5M of phosphoric acid, followed by the selective etch of Cu in the APS etchant for 2 minutes. This resulted in a 0.6 μm thick active layer of Pd nanoplugs located within the pores approximately 5 μm from the membrane surface. Longer Cu deposition time can lead to the active layer being located deeper within the support structure. Increasing the Pd deposition time can result in a thicker active layer. The Al substrate is trimmed to 25 mm diameter.

Testing of both the blank AAO structure and the AAO/Pd membranes demonstrate that, when properly supported, the membranes withstand pressures up to 100 psi, and possibly higher, as 100 psi is the upper limit of the test system. Further, temperatures up to 650° C. (for membranes with an Al rim) and 850° C. (for membranes without Al rim) can be withstood.

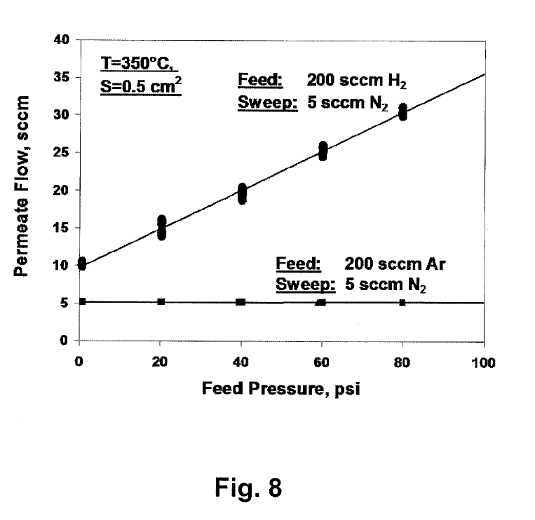

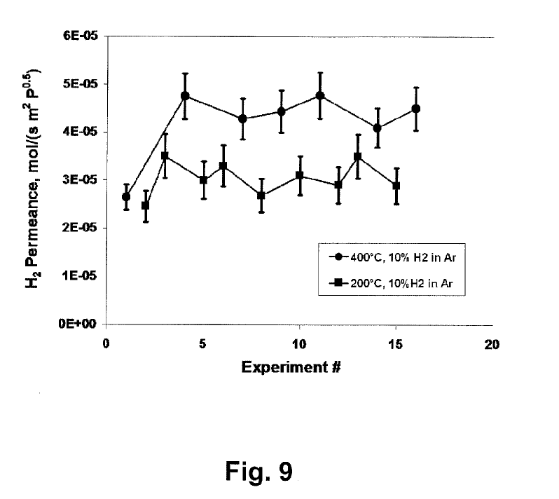

The composite AAO/Pd membranes demonstrate H₂ permeance of up to 0.8 mmol/s/m²/Pa^{0.5} at 250° C. to 350° C. (FIG. 8), and permselectivity (i.e., the ratio of permeability of hydrogen to argon) up to 1000. Comparison of blank and composite membrane permeability show that AAO will not limit the composite membrane performance for the targeted length of Pd nanoplugs. Composite AAO/Pd membranes also demonstrate excellent resistance to repeated thermal cycling from 200° C. to 400° C. in the presence of H₂, with no noticeable impact on permeability, permselectivity and membrane integrity (FIG. 9). No negative effects of H₂ embrittlement and no leaks are detected as a result of temperature cycling. SEM photomicrographs do not reveal any changes in nanoplug morphology, which remains conformal to the pore walls.

### Example 7

### Composite AAO/(ZnO—Cu)/Pd Membrane-Reactor for Methanol Reforming

Composite AAO/Pd membranes on Al foil substrates are fabricated as previously noted in Example 5. A thin layer of a steam reforming catalyst (ZnO doped with Cu) is applied to the pore walls by dip-coating in a 0.5M solution of copper and zinc acetates in isopropanol, followed by blotting of excess solution, drying at 100° C. for 5 min and burn-out for 10 min at 350° C. Following 5 to 20 catalyst coatings, membranes are annealed up to 750° C. for 1 hr to stabilize the composition and the crystal structure of the catalyst, and reduced at up to 500° C. for 1 hr in 5% H₂ in Ar to form nanostructured Cu catalyst particles. These nanochannel membrane-reactors are tested for H₂ generation by steam reforming of methanol and demonstrated space velocity superior to bulk catalysts.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A method for fabricating an anodic aluminum oxide structure having a plurality of support layer pore channels, comprising the steps of:
providing an aluminum metal substrate;
contacting the aluminum metal substrate with an electrolyte; and
anodizing the aluminum metal substrate in contact with the electrolyte at a first anodizing voltage of at least about 100V,
wherein the electrolyte comprises at least one electrolyte component selected from the group consisting of:
i) metal salts of a pore forming electrolyte acid selected from oxalic acid, sulfuric acid, phosphoric acid, citric acid and malonic acid;
ii) a non-pore forming compound selected from the group consisting of boric acid, sodium borate, ammonium borate, ammonium phosphate, ammonium oxalate, and ammonium adipate; and
iii) an organic polar solvent.

2. A method as recited in claim 1, wherein the first anodizing voltage is at least about 200V.

3. A method as recited in claim 1, wherein the first anodizing voltage is from about 200V to about 1000V.

4. A method as recited in claim 1, wherein the first anodizing voltage is from about 200V to about 600V.

5. A method as recited in claim 1, wherein the electrolyte comprises a pore-forming electrolyte acid selected from the group consisting of oxalic acid, sulfuric acid, phosphoric acid, citric acid and malonic acid.

6. A method as recited in claim 5, wherein the electrolyte component comprises a metal salt of the pore forming electrolyte acid.

7. A method as recited in claim 6, wherein the metal salt comprises an oxalate salt.

8. A method as recited in claim 6, wherein the metal salt comprises a complex salt, the complex salt comprising at least a first cation selected from Group I or Group II elements and at least a second cation selected from Group III or Group IV elements.

9. A method as recited in claim 8, wherein the first cation of the complex salt is selected from potassium, calcium and magnesium.

10. A method as recited in claim 8, wherein the second cation of the complex salt is selected from aluminum and titanium.

11. A method as recited in claim 1, wherein the electrolyte comprises a pore forming electrolyte acid selected from the group consisting of oxalic acid, sulfuric acid, phosphoric acid, citric acid and malonic acid, and mixtures thereof, and a non-pore forming compound selected from the group consisting of boric acid, sodium borate, ammonium borate, ammonium phosphate, ammonium oxalate and ammonium adipate.

12. A method as recited in claim 1, wherein the electrolyte comprises a pore forming acid and an organic polar solvent.

13. A method as recited in claim 12, wherein the organic polar solvent comprises an alcohol.

14. A method as recited in claim 1, further comprising the step of forming a non-porous layer of aluminum oxide on the aluminum metal substrate before anodizing the substrate at the first anodizing voltage.

15. A method as recited in claim 1, further comprising the step of applying a mask to the aluminum substrate before the anodizing step to selectively anodize a portion of the aluminum metal substrate.

16. A method as recited in claim 1, wherein the support layer pore channels have an average pore diameter of at least about 200 nm and an average pore period of at least about 500 nm.

17. A method as recited in claim 1, wherein the support layer pore channels have an average pore diameter of at least about 1000 nm and an average pore period of at least about 2000 nm.

18. A method as recited in claim 1, further comprising the step of second anodizing the aluminum metal substrate at a second anodizing voltage, wherein the second anodizing voltage is less than the first anodizing voltage, to form an active layer in the aluminum oxide structure comprising active layer pore channels having an average pore diameter that is less than the diameter of the support layer pore channels.

19. A method as recited in claim 18, wherein the second anodizing voltage is reduced during the second anodizing step.

20. A method for fabricating an anodic aluminum oxide structure having a plurality of support layer pore channels, comprising the steps of:
providing an aluminum metal substrate;
contacting the aluminum metal substrate with a non-pore forming electrolyte;
first anodizing the aluminum metal substrate in contact with the non-pore forming electrolyte at a first anodizing voltage to form a substantially non-porous layer of aluminum oxide on the aluminum metal substrate;
after the first anodizing step, contacting the aluminum metal substrate with a pore forming electrolyte; and
second anodizing the aluminum metal substrate in contact with the pore forming electrolyte at a second anodizing voltage of at least about 100V to form an anodic aluminum oxide structure having a plurality of support layer pore channels.

21. A method as recited in claim 20, wherein the non-pore forming electrolyte comprises a compound selected from the group consisting of boric acid, sodium borate, ammonium borate, ammonium phosphate, ammonium oxalate and ammonium adipate.

22. A method as recited in claim 20, wherein the first anodizing step is carried out for a period of time such that the non-porous layer of aluminum oxide has a thickness of at least about 1 nm and not greater than about 5000 nm.

23. A method as recited in claim 20, wherein the second anodizing voltage is at least about 200V.

24. A method as recited in claim 20, wherein the second anodizing voltage is from about 200V to about 1000V.

25. A method as recited in claim 20, wherein the second anodizing voltage is from about 400V to about 600V.

26. A method as recited in claim 20, wherein the pore forming electrolyte comprises an acid selected from the group consisting of oxalic acid, sulfuric acid, phosphoric acid, citric acid, malonic acid and mixtures thereof.

27. A method as recited in claim 20, wherein the support layer pore channels have an average pore diameter of at least about 200 nanometers and an average pore period of at least about 500 nanometers.

28. A method as recited in claim 20, further comprising the step of chemically etching the support layer pore channels to increase the pore diameter of the support layer pore channels.

29. A method as recited in claim 20, wherein the pore forming electrolyte comprises at least one electrolyte component selected from the group consisting of:
i) metal salts of a pore-forming electrolyte acid selected from oxalic acid, sulfuric acid, phosphoric acid, citric acid and malonic acid;
ii) a non-pore forming acid selected from the group consisting of boric acid, sodium borate, ammonium borate, ammonium phosphate, ammonium oxalate and ammonium adipate; and
iii) an organic polar solvent.

30. A method as recited in claim 20, further comprising the step of third anodizing the aluminum metal substrate at a third anodizing voltage, wherein the third anodizing voltage is less than the second anodizing voltage, to form an active layer in the aluminum oxide structure comprising active layer pore channels having an average pore diameter that is less than the diameter of the support layer pore channels.

31. A method as recited in claim 30, wherein the third anodizing voltage is reduced during the third anodizing step.

32. A method for the fabrication of an anodic aluminum oxide structure having a plurality of support layer pore channels, comprising the steps of:
providing an aluminum metal substrate;
contacting the aluminum metal substrate with a first pore forming electrolyte;
first anodizing the aluminum metal substrate in contact with the pore forming electrolyte by applying a first anodizing voltage to the aluminum metal substrate to form an anodic aluminum oxide structure, where the anodic aluminum oxide structure comprises a base layer comprising the plurality of support layer pore channels and a barrier layer disposed between the base layer and the aluminum metal substrate;
contacting the aluminum oxide structure with a second electrolyte; and
electrochemically removing at least a portion of the barrier layer to form secondary pores in the barrier layer.

33. A method as recited in claim 32, wherein the electrochemically removing step comprises the step of applying a dissolution voltage across the barrier layer while in contact with the second electrolyte, wherein the second electrolyte comprises an acid selected from the group consisting of hydrochloric acid, perchloric acid, acetic acid and mixtures thereof.

34. A method as recited in claim 32, wherein the dissolution voltage is at least about 0.5 V and not greater than about 1000 V.

35. A method as recited in claim 32, wherein the dissolution voltage is at least about 2 V and not greater than about 400 V.

36. A method as recited in claim 32, wherein the step of electrochemically removing at least a portion of the barrier layer separates the anodic aluminum oxide structure from the aluminum metal substrate.

37. A method as recited in claim 32, wherein the secondary pores have an average diameter in the range of from about 1 nm to about 300 nm and that is not greater than the average diameter of the pore channel.

38. A method as recited in claim 32, further comprising the step of second anodizing the aluminum metal substrate at a second anodizing voltage, wherein the second anodizing voltage is less than the first anodizing voltage, to form an active layer in the aluminum oxide structure comprising active layer pore channels having an average pore diameter that is less than the diameter of the support layer pore channels.

39. A method as recited in claim 38, wherein the second anodizing voltage is reduced during the second anodizing step.

40. A method for fabricating an anodic aluminum oxide structure having a plurality of support layer pore channels, comprising the steps of:
providing an aluminum metal substrate;
contacting the aluminum metal substrate with a first pore forming electrolyte;
first anodizing the aluminum metal substrate to form a first anodic aluminum oxide layer by applying a first anodizing voltage to the aluminum metal substrate;
applying a protective coating over at least a portion of the first anodic aluminum oxide layer;
contacting the aluminum metal substrate with a second pore forming electrolyte; and
second anodizing the aluminum metal substrate in contact with the second pore forming electrolyte to form a second anodic aluminum oxide layer, where the first anodic aluminum oxide layer and the second anodic aluminum oxide layer form an anodic aluminum oxide structure having an average thickness of at least about 100 μm, and
wherein the protective coating is substantially insoluble in the second pore forming electrolyte.

41. A method as recited in claim 40, wherein the second pore forming electrolyte is the same as the first pore forming electrolyte.

42. A method as recited in claim 40, wherein the protective coating is selected from a polymer or a metal oxide.

43. A method as recited in claim 40, wherein the protective coating is a polymer coating.

44. A method as recited in claim 43, wherein the applying step comprising dip-coating the first anodic aluminum oxide layer in a polymer solution.

45. A method as recited in claim 40, wherein the protective coating comprises a self-assembled layer.

46. A method as recited in claim 40, wherein the protective coating is applied to the first anodic aluminum oxide layer in a liquid phase.

47. A method as recited in claim 40, wherein the protective coating is applied to the first anodic aluminum oxide layer in a gas phase.

48. A method as recited in claim 40, wherein the first anodic aluminum oxide layer has a thickness of not greater than about 200 μm.

49. A method as recited in claim 40, wherein the anodic aluminum oxide structure has an average thickness of at least about 2 mm.

50. A method as recited in claim 40, further comprising the steps of:
applying a second protective coating over at least a portion of the second anodic aluminum oxide layer;
contacting the aluminum metal substrate with a third pore forming electrolyte; and
third anodizing the aluminum metal substrate in contact with the third pore forming electrolyte to form a third anodic aluminum oxide layer,
wherein the second protective coating is substantially insoluble in the third pore forming electrolyte, and
wherein the anodic aluminum oxide structure has an average thickness of at least about 2 mm.

51. A method as recited in claim 40, further comprising the step of anodizing the aluminum metal substrate at a decreased anodizing voltage, wherein the decreased anodizing voltage is less than the first anodizing voltage, to form an active layer in the aluminum oxide structure comprising active layer pore channels having an average pore diameter that is less than the diameter of the support layer pore channels.

52. A method as recited in claim 51, wherein the decreased anodizing voltage is reduced during the decreased anodizing step.
